(19) United States
(12) Patent Application Publication
(10) Pub. No.: US 2005/0147290 A1
(43) Pub. Date: Jul. 7, 2005

(54) Quality inspection system for fasteners

(76) Inventors: Hock Seh Ong, Singapore (SG); Ta Seng Jeffrey Mah, Singapore (SG)

Correspondence Address: Lawrence Y.D. Ho & Associates;George D. Liu, PMB 400, 2101 Crystal Plaza Arc, Arlington, VA, 22202, US

(21) Appl. No.: 10/747,445

(22) Filed: Dec. 30, 2003

(51) Int. Cl. G06K 9/00

(52) U.S. Cl. 382/152

(57) ABSTRACT

A quality inspection system for non-contact inspection of fasteners is disclosed. The quality inspection system includes a holder having a plurality of see-through slots for receiving a plurality of fasteners to be inspected, each fastener having a head and a shank. Each slot is configured so as to receive a fastener with the head of the fastener facing upward and the shank suspending in the slot. The holder is mounted onto a linear actuator, which is operable to move the holder along the length of the linear actuator. A vision inspection camera is positioned along the length of the linear actuator and is oriented so that an unobstructed side-view image of each fastener can be captured by the camera. An image analyzer is operatively connected to the vision inspection camera for analyzing the captured image in order to determine whether the fastener is acceptable.

### BACKGROUND OF THE INVENTION

1. Field of the Invention

The invention relates generally to a system and a method for inspecting fasteners, such as screws.

2. Description of the Prior Art

In assembly operations where fasteners such as threaded screws are automatically installed by a machine, defective fasteners cause damage to the product being assembled, resulting in costly repairs. Thus, it is critical for quality control to inspect fasteners for surface flaws prior to use. In the past, fasteners have been manually and visually inspected by workers. However, threaded fasteners are normally made at a high volume, e.g. several thousand fasteners per hour. Visual inspection to sort out defected fasteners from such high volume production has been known to be very time consuming and lacking in adequate precision. Sampling programs were implemented for monitoring the quality of high volume production of threaded fasteners. However, recent zero defect demands for threaded fasteners by the end users have resulted in the requirement that the fastener suppliers inspect 100 percent of the threaded fasteners prior to shipping to the end users. Statistical sampling is no longer an acceptable testing technique.

There is an increasing need for an evaluation of all critical dimensional criteria of individual threaded fasteners by the suppliers to ensure that defective threaded fasteners are removed before shipment.

As an attempt to provide 100 percent inspection of threaded fasteners, several non-contact inspection systems have been developed for automatically performing various inspections.

U.S. Pat. No. 4,457,622, issued to Kato et al., discloses a screw inspection device, which includes a screw transfer mechanism, a sensor for performing predetermined measurements of the screw during the transfer, a comparator for generating acceptance/non-acceptance signals, and a sorter for classifying the screws into defective and nondefective screws.

U.S. Pat. No. 4,598,998, issued to Kamei et al., discloses an inspection system in which light is projected onto the threaded surface of a fastener, and the surface flaws are detected based on the variation of the intensity of the reflected light.

U.S. Pat. No. 4,823,396, issued to Thompson, discloses an automated inspection device, which includes a camera for producing a video image of a fastener and a computer for comparing the actual dimensions of the fastener with the desired dimensions.

U.S. Pat. No. 5,823,356, issued to Goodrich et al., discloses an inspection device in which threaded fasteners can be continuously supplied and moved into a test station where the threaded profiles of the fasteners are functionally tested. A plurality of sensors are disposed along the transfer path through the inspection device to perform predetermined measurements of the specified dimensional characteristics of the fasteners. A sorting device is disposed close to the end of the transfer path to separate defective fasteners from non-defective ones.

Although conventional non-contact inspection systems are very useful, they all have certain limitations. One limitation is that the types of flaws detected are limited. In order to increase the number of geometry features to be inspected, a complex set-up of sensors and hardware would be required. Another limitation is that the conventional inspection systems are not easily adapted for different fastener sizes and types.

### SUMMARY OF THE INVENTION

The present invention is directed to a quality inspection system for non-contact inspection of fasteners at high-speed. The inspection system of the present invention comprises a holder having a plurality of see-through slots for receiving a plurality of fasteners to be inspected, each fastener having a head and a shank. Each slot is configured so as to receive a fastener with the head of the fastener facing upward and the shank suspending in the slot. The holder is mounted onto a linear actuator, which is operable to move the holder along the length of the actuator. A vision inspection camera is positioned along the length of the linear actuator for capturing a side-view image of each fastener when the holder is moved next to the camera. An image analyzer is operatively connected to the vision inspection camera for analyzing the captured image in order to determine whether the fastener is acceptable.

The advantages and novel features of the present invention will become apparent from the following detailed description of the invention when considered in conjunction with the accompanying drawings.

### BRIEF DESCRIPTION OF THE PREFERRED EMBODIMENT

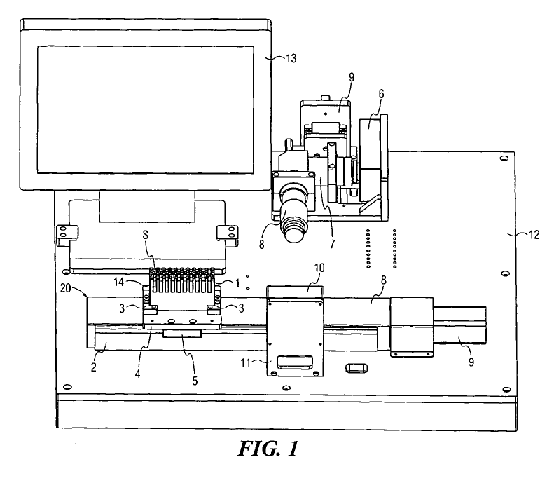

FIG. 1 is a schematic view of the quality inspection system according to the preferred embodiment of the present invention.

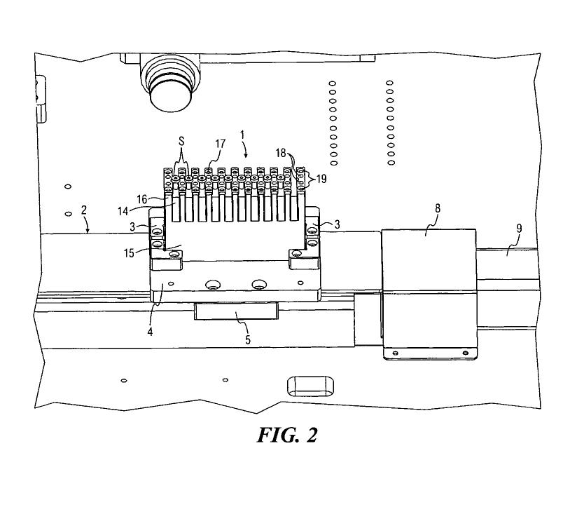

FIG. 2 shows an enlarged perspective view of the fastener holder according to the present invention.

### DETAILED DESCRIPTION OF THE PREFERRED EMBODIMENT

Referring to FIG. 1, the quality inspection system according to the preferred embodiment of the present invention is a compact assembly that is capable of inspecting various geometry features of a fastener at high speed. A holder 1 having a plurality of see-through slots is provided for holding a plurality of fasteners to be inspected. The holder 1 is supported on a fixture plate 4, which is connected to a carrier 5. The fixture plate 4 is mounted onto a linear actuator 2, which is operable to move the carrier 5 along the length of the linear actuator 2. The linear actuator 2 includes a protective cover 8 and a motor 9 operable for moving the carrier 5. Guides 3 are provided on the fixture plate 4 for positioning the holder 1 on the fixture plate 4. A vision inspection camera 6 is positioned at a location along the length of the linear actuator 2. The camera 9 is provided with a 90° lens 7 and a zoom lens 8. A back-light 10 is provided for shedding adequate lighting onto the holder 1 for the camera 6. The camera 6 and the back-light 10 are arranged on opposite sides of the linear actuator 2. The linear actuator 2, the camera 6 and the back-light 10 are mounted onto a common base 12. A vertically moveable bracket 9 is used for mounting the camera 6 to the base 12. The bracket 9 is movable so as to enable the inspection of different fastener lengths. A bracket 11 is used for mounting the back-light 10 to the base 102. An image processing computer (not shown) is operatively connected to the camera 6 for processing the image captured by the camera 6. A display monitor 13 connected to the image processing computer is mounted onto the base 12 for displaying the relevant data.

Referring to FIG. 2, the holder 1 has two opposing side wall surfaces 15 and a plurality of see-through slots 14 extending from one side wall surface to the other. A plurality of support plates 17 are mounted on top of the holder 1 and are spaced from each other so as to define a plurality of spacings that align with the slots 14. The spacings between the support plates 17 are sized so that the heads of the fasteners can rest on the support plates 17 while the shanks are suspending in the slots 14. The holder 1 is changeable to accommodate different fastener sizes.

During the operation of the quality inspection system, a plurality of fasteners are placed on the holder 1 while the holder 1 is at the upstream end 20 of the linear actuator 2. The holder 1 is then moved downstream along the linear actuator 2 until a fastener held by the holder 1 is aligned in front of the camera 6. Each slot is sequentially oriented relative to camera 6 so that an unobstructed side-view image of each fastener can be captured. The holder 1 is intermittenly stopped and moved in front of the camera 6 until the side-view images of all fasteners are captured. Each captured image of the fastener is then analyzed by the image processing computer. The image processing computer has the inspection criteria for the acceptable fasteners pre-stored in its memory. The inspection criteria include: head height, head diameter, shank length, thread pitch, underfill, over 1-pitch, and other programmable dimensions. The computer compares the actual dimensions of the fastener with the pre-stored inspection criteria, then determines whether the fastener is acceptable. The display monitor 13 is operable to display the fastener information, the inspection results, and other relevant data.

The quality inspection system of the present invention is capable of fast changeover time for different fastener types and sizes. Other advantages include: minimum product failure; minimum maintenance required; and the hardware and software can be upgradeable, ease of recording, data integrity.

Although the preferred embodiment of the present invention has been described herein, it should be understood that the invention is not confined to the details and drawings described above, but may be modified within the scope of the appended claims.

1. A quality inspection system for non-contact inspection of fasteners, said system comprising:
a holder having two opposing side wall surfaces and a plurality of slots extending from one side wall surface to the other, the slots being configured to receive a plurality of fasteners, each fastener having a head and a shank;
a linear actuator connected to the holder and operable to move the holder along the length of the linear actuator;
a vision inspection camera positioned along the length of the linear actuator for capturing a side-view image of each fastener; and
an image analyzer operatively connected to the vision inspection camera for analyzing the captured image in order to determine whether the fastener shown in the captured image is acceptable.

2. The quality inspection system of claim 1, wherein the holder is movably mounted onto the linear actuator with the length of each slot oriented substantially perpendicular to the length of the linear actuator.

3. The quality inspection system of claim 1, wherein a plurality of support plates are mounted on top of the holder so as to define spacings, the spacings being aligned with the slots so that the heads of the fasteners can rest on top of the support plates while the shanks extend into the slots.

4. The quality inspection system of claim 1 further comprising a back-light positioned along the length of the linear actuator in order to provide lighting for the vision inspection camera.

5. A method for inspecting a plurality of fasteners, each having a head and a shank, said method comprising the steps of:
providing a fastener inspection system comprising:
(a) a holder having two opposing side wall surfaces and a plurality of slots extending from one side wall surface to the other, the slots being configured to receive a plurality of said fasteners;
(b) a linear actuator connected to the holder and operable to move the holder along the length of the linear actuator;
(c) a vision inspection camera positioned along the length of the linear actuator for capturing a side-view image of each fastener; and
(d) an image analyzer operatively connected to the vision inspection camera for analyzing the captured image in order to determine whether the fastener shown in the captured image is acceptable;
placing a plurality of said fasteners into the slots so that the heads of said fasteners are facing upward and the shanks are suspending in the slots;
activating the linear actuator so as to move the holder next to the vision inspection camera;
capturing an unobstructed side-view image of each fastener while the fasteners are placed in the slots using an image inspection camera; and
analyzing the captured image to determine whether the fastener shown in the captured image is acceptable.
